(19) United States
(12) Patent Application Publication
(10) Pub. No.: US 2007/0129879 A1
(43) Pub. Date: Jun. 7, 2007

(54) Precision approach guidance using global navigation satellite system (GNSS) and ultra-wideband (UWB) technology

(75) Inventor: Neal R. Fedora, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/296,013

(22) Filed: Dec. 7, 2005

(51) Int. Cl. G01C 21/00

(52) U.S. Cl. 701/200; 701/213

(57) ABSTRACT

Improved precision navigation systems and methods are provided. In one embodiment, a navigation system is provided. The system comprises a global navigation satellite system receiver adapted to output information representing the location of a vehicle based on one or more signals from one or more satellites; an ultra-wideband ranging system adapted to output information representing the location of the vehicle based on one or more ultra-wideband signals; and a vehicle guidance system coupled to receive the location output from the global navigation satellite system receiver and the location output from the ultra-wideband ranging system. The vehicle guidance system is adapted to maneuver the vehicle based on the information from at least one of the global navigation satellite system receiver and the ultra-wideband ranging system based on a distance of the vehicle from a target object.

### TECHNICAL FIELD

The present invention generally relates to space based navigation and more specifically to navigation systems and more specifically to automated maneuvering of spacecraft.

### BACKGROUND

The advent of automated space vehicles has presented the need for precision guidance systems. Precision guidance systems are necessary for missions requiring automated docking such as, but not limited to, the recent Orbital/NASA Demonstration of Autonomous Rendezvous Test (DART) vehicle mission, and future missions for spacecraft, such as maintaining the Hubble telescope, for example. The precision of a Global Navigation Satellite System (such as the Global Positioning System (GPS), Global Orbiting Navigation Satellite System (GLONASS), and Galileo) provides an accuracy of a few meters at best, with high susceptibility to multipath, thus it is not accurate enough for performing precision docking and maneuvering. Currently the limitations of GNSSs are compensated by allowing humans to control the final docking approach via video guidance. There is a need for a higher accuracy solution that provides completely automated landings and dockings for unmanned space vehicles.

For the reasons stated above and for other reasons stated below which will become apparent to those skilled in the art upon reading and understanding the specification, there is a need in the art for improved precision navigation systems and methods.

### SUMMARY

The Embodiments of the present invention provide methods and systems for improved precision approach guidance systems and methods and will be understood by reading and studying the following specification.

In one embodiment, a navigation system is provided. The system comprises a global navigation satellite system receiver adapted to output information representing the location of a vehicle based on one or more signals from one or more satellites; an ultra-wideband ranging system adapted to output information representing the location of the vehicle based on one or more ultra-wideband signals; and a vehicle guidance system coupled to receive the location output from the global navigation satellite system receiver and the location output from the ultra-wideband ranging system. The vehicle guidance system is adapted to maneuver the vehicle based on the information from at least one of the global navigation satellite system receiver and the ultra-wideband ranging system based on a distance of the vehicle from a target object.

In another embodiment, a method for maneuvering a vehicle is provided. The method comprises receiving position information from one or more global navigation satellite system satellites; receiving position information from an ultra-wideband ranging system; and maneuvering a vehicle based on at least one of the position information from the global navigation satellite system satellites and the position information from the ultra-wideband ranging system based on a distance between the vehicle and a target object

In yet another embodiment, a navigation system is provided. The system comprises means for determining a position of a vehicle based on one more signals from one or more satellites; means for determining a distance between the vehicle and a target object based on an ultra-wideband ranging system; and means for guiding the position of the vehicle based on at least one of the position of a vehicle determined from the one more signals from one or more satellites and the distance between the vehicle and the target object determine from the ultra-wideband ranging system based on a distance between the vehicle and the target object, the means for guiding responsive to the means for determining a position and the means for determining a distance.

### DRAWINGS

Embodiments of the present invention can be more easily understood and further advantages and uses thereof more readily apparent, when considered in view of the description of the embodiments and the following figures in which:

FIG. 1 is a block diagram of a navigation system of one embodiment of the present invention;

FIG. 2 is a diagram illustrating a navigation system of one embodiment of the present invention; and

FIG. 3 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide a high accuracy solution for completely automated landings and dockings of space vehicles by utilizing both a Global Navigation Satellite System (GNSS) and Ultra Wideband (UWB) ranging systems, such as UWB radar and positioning localizers, for space based docking and maneuvering. Embodiments of the present invention provide centimeter accuracy ranging information to enable automated maneuvering of a space vehicle, enough to meet the requirements for landing and docking. Further, embodiments of the present invention provide this degree of accuracy at a low cost by utilizing existing GNSS and UWB technologies. Thus, future manned and unmanned space missions are readily able to utilize the unique systems and methods of the present invention for accurate space vehicle approaches and maneuvering. Further, embodiments of the present invention reduce vehicle cost and weight due to video guidance systems, while providing the equivalent or superior accuracy.

Embodiments of the present invention utilize GNSS receivers on a space vehicle for general positioning information and vehicular approach guidance to place the space vehicle within the proximate vicinity of a destination target (e.g. a second space vehicle). As the space vehicle approaches the destination target, onboard guidance systems rely less on the GNSS receivers and more heavily on an onboard UWB ranging system. In one embodiment, the space vehicle relies on GNSS receivers to arrive at a general location specified by a set of coordinates. In one embodiment, the space vehicle relies on GNSS receivers until it is within a few tens of meters of the destination target, and then begins incorporating UWB ranging measurements into maneuvering decisions more heavily as it closes in on the destination target. As would be appreciated by one skilled in the art upon reading this specification, UWB ranging systems generally provide sub-centimeter accuracy, as a result of the corresponding high bandwidth/short pulse duration transmissions, which provides an accuracy significantly better than from a GNSS alone.

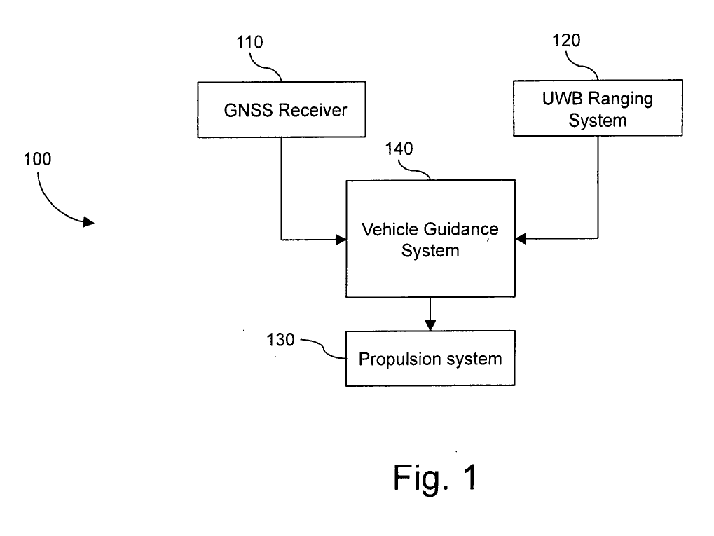

As illustrated in FIG. 1, in one embodiment, a navigation system 100 for a space vehicle comprises a propulsion system 130 coupled to receive navigational instructions for maneuvering the space vehicle from a vehicle guidance system 140. Vehicle guidance system 140 is coupled to receive location information from GNSS receiver 110 and UWB ranging system 120 and operate propulsion system 130 based on the location information.

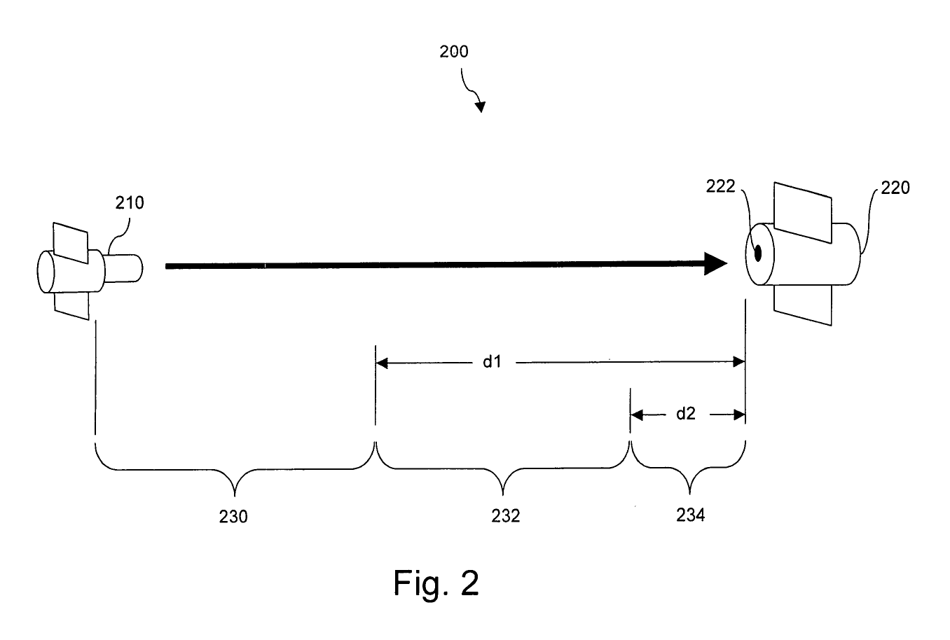

Referring to both FIG. 1 and FIG. 2, in one embodiment, in operation, vehicle guidance system 140 navigates a space vehicle 210 towards a destination space vehicle 220. In one embodiment, when space vehicle 210 is traveling in a region (shown as region 230) with a distance from space vehicle 220 greater than distance d1, vehicle guidance system 140 operates propulsion system 130 to reduce the distance between space vehicles 210 and 220 based on information received from GNSS receiver 110. In one embodiment, GNSS receiver 110 determines the position of space vehicle 210 based on satellite signals from one or more of the Global Positioning System (GPS), the Global Orbiting Navigation Satellite System (GLONASS), and Galileo satellite system, or other satellite based navigation system.

Because of inherent limitations with the GNSS systems, location information from GNSS receiver 110 is capable of guiding space vehicle 210 safely to within several meters of space vehicle 220, but not guide it with the accuracy required for precision maneuvering for approaching and docking with space vehicle 220. Therefore, in one embodiment, when space vehicle 210 is traveling in a region (shown as region 234) with a distance from space vehicle 220 less than distance d2, vehicle guidance system 140 operates propulsion system 130 to reduce the distance between space vehicles 210 and 220 based on information received from UWB ranging system 120. In one embodiment, UWB ranging system 120 is mounted externally to space vehicle 210 and communicates the observed information to the vehicle guidance system 140. UWB ranging system 120 is a UWB radar system that broadcasts signal pulses at space vehicle 220 and based on their reflections from vehicle 160, precisely determines the distance between space vehicles 210 and 220. In one embodiment, UWB ranging system 120 signals reflected back from space vehicle 220 provides vehicle guidance system 140 with data sufficient to map features of target vehicle 160 with an accuracy to within a centimeter. In one embodiment, UWB ranging system 120 is a UWB localizer signal receiver that receives signals transmitted from one or more UWB positioning localizers 222 located on, or in close proximity to space vehicle 220.

As would be appreciated by one of ordinary skill in the art upon reading this specification, such data enables vehicle guidance system 140 to precisely maneuver space vehicle 210 when in close proximity to space vehicle 220. In one embodiment, close proximity maneuvering enables space vehicle 210 to perform one or more high precision operations such as, but not limited to, docking with space vehicle 220, landing in a landing bay within space vehicle 220, and maintaining a close proximity to space vehicle 220 for activities such as performing maintenance on space vehicle 220.

In one embodiment, a greater degree of maneuvering precision is provided by embodiments of the present invention by integrating location information from UWB ranging system 120 into the closed-loop navigation and guidance system provided by GNSS receiver 110 and vehicle guidance system 140. In one embodiment, when space vehicle 210 is traveling in a region (shown as region 232) with a distance from space vehicle 220 less than distance d1 and greater than distance d2, vehicle guidance system 140 operates propulsion system 130 to reduce the distance between space vehicles 210 and 220 based on information received from both GNSS receiver 110 and UWB ranging system 120. In one embodiment, vehicle guidance system 140 transitions from relying primarily on GNSS receiver 110 (near distance d1) to relying primarily on UWB ranging system 120 (near distance d2) by weighing information from GNSS receiver 110 more heavily as space vehicles 210 first comes within distance d1 from space vehicle 220 and weighing information from UWB ranging system 120 more heavily when space vehicle 210 approaches distance d2 from space vehicle 220. In one embodiment, vehicle guidance system 140 utilizes a weighted average of the location information provided by GNSS receiver 110 and UWB ranging system 120 where the weighting is a function of the distance between space vehicles 120 and 220. Although in some embodiments the weighting function may be linear (e.g., with information from GNSS receiver 110 and UWB ranging system 120 each weighted at 50% for maneuvering at a distance of (d1-d2)/2), embodiments encompassing non-linear weighting of the information from GNSS receiver 110 and UWB ranging system 120 are also contemplated, such as, but not limited to, the non-stationary Kalman filtering technique. Additionally, as would be appreciated by one of ordinary skill in the art, distances d1 and d2 are readily determined based on the specifics of an application. In one embodiment distance d1 is approximately 10 meters and distance d2 is approximately 2 meters.

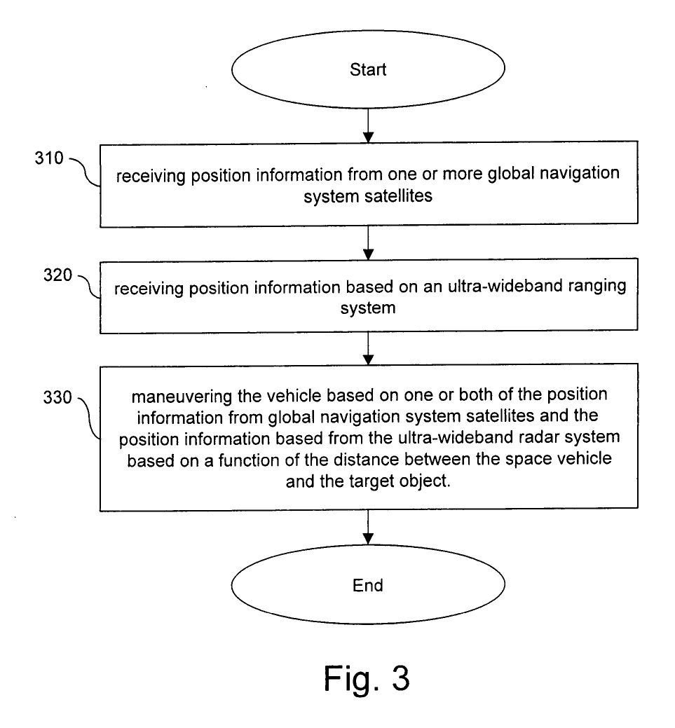

FIG. 3 is a flow diagram illustrating a method for maneuvering a space vehicle of one embodiment of the present invention. The method beings at 310 with receiving position information from one or more global navigation satellite system satellites. As would be appreciated by one skilled in the art, position information from global navigation satellite system satellites is sufficiently reliable and accurate for purposes maneuvering a space vehicle for many thousands of miles to within a few tens of meters of a target destination. The method also includes at 320 receiving position information based on an ultra-wideband ranging system. Ultra-wideband radar and localizer ranging systems generally provide sub-centimeter accuracy by transmitting high bandwidth/short pulse duration signals, which allows precision maneuvering of a space vehicle in proximity to a target object at the target destination. In one embodiment, the ultra-wideband ranging system is an ultra-wideband radar system that reflects UWB radar signals off the target object. In one embodiment, the ultra-wideband ranging system is an ultra-wideband localizer receiver that receives ultra-wideband signals transmitted from one or more ultra-wideband position localizers on or near the target object. Although the target object has been illustrated as solid matter, such as another vehicle, target objects comprising any form of matter capable of reflecting an ultra-wideband radar signal are contemplated. The method proceeds to 330 with maneuvering the space vehicle based on one or both of the position information from global navigation satellite system satellites and the position information based from the ultra-wideband radar system. In one embodiment, information from global navigation satellite system satellites and the position information are weighted based on a function of the distance between the space vehicle and the target object. In one embodiment, the space vehicle is maneuvered primarily based on the position information from global navigation satellite system satellites when the space vehicle is at relatively farther distances from the target object and primarily based on the position information based from the ultra-wideband radar system when the space vehicle is at relatively closer distances from the target object. In one embodiment, when the space vehicle is at a distance greater than distance d1 (shown in FIG. 2), the space vehicle maneuvers based on the global navigation satellite system satellites. In one embodiment, when the space vehicle is at a distance less than distance d2 (shown in FIG. 2), the space vehicle maneuvers based on the ultra-wideband radar system.

Although embodiments of the present invention are mainly illustrated in terms of a space vehicle, embodiments of the present invention are not so limited as the scope of the present invention encompasses other embodiments where vehicles require high accuracy automatic navigation to a final destination. For example, in one embodiment propulsion system 140 is comprised of a drive train on an automobile and vehicle guidance system 130 is configured to guide the automobile using GNSS signals and shifts to UWB radar to precisely navigate the automobile to a selected destination (e.g., a parking space in a garage), based on the distance between the automobile and the selected destination, as described above.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A navigation system, the system comprising:
a global navigation satellite system receiver adapted to output information representing the location of a vehicle based on one or more signals from one or more satellites;
an ultra-wideband ranging system adapted to output information representing the location of the vehicle based on one or more ultra-wideband signals; and
a vehicle guidance system coupled to receive the location output from the global navigation satellite system receiver and the location output from the ultra-wideband ranging system;
wherein the vehicle guidance system is adapted to maneuver the vehicle based on the information from at least one of the global navigation satellite system receiver and the ultra-wideband ranging system based on a distance of the vehicle from a target object.

2. The system of claim 1, wherein the ultra-wideband ranging system is adapted to output information representing the location of the vehicle based on one or more ultra-wideband signals received from one or more ultra-wideband positioning localizers.

3. The system of claim 1, wherein the ultra-wideband ranging system comprises an ultra-wideband radar, the ultra-wideband radar adapted to output information representing the location of the vehicle based on one or more signals reflected from the target object.

4. The system of claim 1, wherein one or both of the vehicle and the target object comprise a space vehicle.

5. The system of claim 1, wherein the vehicle guidance system is further adapted to weight the information from the global navigation satellite system receiver greater than information from the ultra-wideband ranging system when the vehicle is at relatively larger distances from the target object, and weight the information from the ultra-wideband ranging system greater than information from the global navigation satellite system receiver when the vehicle is at relatively shorter distances from the target object.

6. The system of claim 5, wherein the vehicle guidance system is further adapted to maneuver the vehicle in order to at least one of dock with the target object, land on the target object, and maintain close proximity to the target object, based the information from the ultra-wideband ranging system.

7. The system of claim 5, wherein when the vehicle is traveling in a first region with a distance from the target object greater than a first distance, the vehicle guidance system is adapted to operate a propulsion system to reduce the distance between the vehicle and a target destination based on information received from the global navigation satellite system receiver; and
when the vehicle is traveling in a second region with a distance from the target object less than a second distance, the vehicle guidance system is further adapted to operate the propulsion system to reduce the distance between the vehicle and the target object based on information received from the ultra-wideband ranging system.

8. The system of claim 7, wherein when the target destination comprises one or both of the location of the target object and a location specified by coordinates.

9. The system of claim 7, wherein when the vehicle is traveling in a third region with a distance from the target object less than the first distance and greater than the second distance, the vehicle guidance system is further adapted to operate the propulsion system to reduce the distance between the vehicle and the target object based on the information received from both the global navigation satellite system receiver and the ultra-wideband ranging system.

10. The system of claim 7, wherein the vehicle guidance system is adapted to transition from maneuvering the vehicle based on the global navigation satellite system receiver to maneuvering the vehicle based on the ultra-wideband ranging system.

11. The system of claim 10, wherein the vehicle guidance system is further adapted to weigh information from the global navigation satellite system receiver and the ultra-wideband ranging system as a function of the distance of the vehicle from the target object.

12. A method for maneuvering a vehicle, the method comprising:
receiving position information from one or more global navigation satellite system satellites;
receiving position information from an ultra-wideband ranging system; and
maneuvering a vehicle based on at least one of the position information from the global navigation satellite system satellites and the position information from the ultra-wideband ranging system based on a distance between the vehicle and a target object.

13. The method of claim 12, wherein receiving position information from an ultra-wideband ranging system further comprises receiving one or more ultra-wideband signal from one or more ultra-wideband positioning localizers.

14. The method of claim 12, wherein receiving position information from an ultra-wideband ranging system further comprises receiving one or more ultra-wideband radar signals reflected from the target object.

15. The method of claim 12, wherein maneuvering the vehicle further comprises weighting the information from the one or more global navigation satellite system satellites and the information from the ultra-wideband ranging system based on the distance between the vehicle and the target object.

16. The method of claim 12, wherein maneuvering the vehicle further comprises maneuvering the vehicle primarily based on the position information from the one or more global navigation satellite system satellites when the vehicle is at a relatively farther distance from a target object, and primarily based on the position information the ultra-wideband ranging system when the vehicle is at a relatively closer distance from the target object.

17. The method of claim 12, wherein maneuvering the vehicle further comprises maneuvering the vehicle in order to at least one of dock with the target object, land on the target object, and maintain close proximity to the target object.

18. The method of claim 12, wherein when the vehicle is traveling in a first region with a distance from the target object greater than a first distance, maneuvering the vehicle further comprises operating a propulsion system to reduce the distance between the vehicle and the target object based on the position information from the one or more global navigation satellite system satellites; and
when the vehicle is traveling in a second region with a distance from the target object less than a second distance, maneuvering the vehicle further comprises operating the propulsion system to reduce the distance between the vehicle and the target object based on information received from the ultra-wideband ranging system.

19. The method of claim 18, wherein when the vehicle is traveling in a third region with a distance from the target object less than the first distance and greater than the second distance, maneuvering the vehicle further comprises operating the propulsion system to reduce the distance between the vehicle and the target object based on the information received from both the global navigation satellite system receiver and the ultra-wideband ranging system.

20. The method of claim 12, wherein receiving position information from an ultra-wideband ranging system further comprises receiving data mapping features of a target vehicle.

21. A navigation system, the system comprising:
means for determining a position of a vehicle based on one more signals from one or more satellites;
means for determining a distance between the vehicle and a target object based on an ultra-wideband ranging system; and
means for guiding the position of the vehicle based on at least one of the position of a vehicle determined from the one more signals from one or more satellites and the distance between the vehicle and the target object determine from the ultra-wideband ranging system based on a distance between the vehicle and the target object, the means for guiding responsive to the means for determining a position and the means for determining a distance.

22. The system of claim 21, wherein the means for guiding is further adapted to weight the information from the global navigation satellite system receiver greater than information from the ultra-wideband ranging system when the vehicle is at relatively larger distances from the target object, and weight the information from the ultra-wideband ranging system greater than information from the global navigation satellite system receiver when the vehicle is at relatively shorter distances from the target object.

23. The system of claim 22, wherein when the vehicle is traveling in a first region with a distance from the target object greater than a first distance, the means for guiding is adapted to operate a means for propulsion to reduce a distance between the vehicle and the target object based on information from the means for determining a position of the vehicle; and
when the vehicle is traveling in a second region with a distance from the target object less than a second distance, the means for guiding is further adapted to operate the means for propulsion to reduce the distance between the vehicle and the target object based on information received from the means for determining a distance.

24. The system of claim 23, wherein when the vehicle is traveling in a third region with a distance from the target object less than the first distance and greater than the second distance, the means for guiding is further adapted to operate the means for propulsion to reduce the distance between the vehicle and the target object based on the information received from both the means for determining a position of the vehicle and the means for determining a distance.

25. The system of claim 21, wherein the means for guiding is adapted to transition from maneuvering the vehicle based on information from the means for determining a position of the vehicle to maneuvering the vehicle object based on information received from the means for determining a distance by weighting the information from the means for determining a position of the vehicle and the information received from the means for determining a distance as a function of the distance of the vehicle from the target object.

26. The system of claim 21, wherein the means for determining a position of a vehicle is further adapted to determine position based on one more signals from one or more global navigation satellite system satellites; and
the means for determining a distance is further adapted to determine a distance between the vehicle and the target object based on one or both of ultra-wideband radar signals and ultra-wideband localizer signals.
